(19) United States
(12) Patent Application Publication
(10) Pub. No.: US 2025/0360481 A1
(43) Pub. Date: Nov. 27, 2025

(54) REGOLITH SIMULANT PRODUCTION METHOD AND APPARATUS

(71) Applicant: Blue Origin Manufacturing, LLC, Kent, WA (US)

(72) Inventor: Amelia Diane Greig, Los Angeles, CA (US)

(21) Appl. No.: 18/674,838

(22) Filed: May 25, 2024

(51) Int. Cl. B01J 19/08; B01J 19/00

(52) U.S. Cl. CPC B01J 19/088; B01J 19/0013; B01J 2219/0869; B01J 2219/0871; B01J 2219/0896

(57) ABSTRACT

Systems and methods for producing regolith simulant that has physical properties that are substantially the same as those of actual regolith, such as that of the Moon's surface, are introduced. In particular, these systems and methods may produce regolith simulant particles that have relatively sharp, irregular, and angular shapes. Such shapes and structures are generally the same as or similar to the shapes and structures of lunar regolith particles. These shapes and structures contribute to a number of important physical characteristics demonstrated by lunar regolith. The methods may include forming a dusty plasma inside a chamber, providing components of the regolith simulant into the chamber, and allowing the components to intermix in the dusty plasma to form irregular and angular particles of the regolith simulant.

### BACKGROUND

Lunar regolith is the layer of loose material that covers the surface of the Moon. It is formed by the constant impact of meteoroids and solar wind, and it contains various sizes and shapes of rock fragments, dust particles, and minerals. Lunar regolith mainly comprises silicates, oxides, metals, and volatiles. Its composition varies depending on the location and depth of the regolith. For example, mare regolith is richer in iron and titanium than highland regolith, and deeper regolith may contain more ancient and pristine materials than surface regolith. Lunar regolith particles have irregular shapes and sharp edges due to the lack of weathering and erosion processes on the Moon. The shape affects the mechanical, electrical, and optical properties of the regolith, such as its cohesion, friction, reflectance, and thermal and electrical resistance.

Lunar regolith simulant is a material that replicates the properties of lunar regolith for research and testing purposes. It helps scientists and engineers study the challenges and opportunities of exploring the lunar surface, such as landing, roving, drilling, mining, and building. It also helps researchers investigate the potential uses of lunar regolith as a resource, such as making concrete, bricks, glass, ceramics, metals, and solar cells.

The accuracy of a lunar regolith simulant can be evaluated based on how closely it matches the chemical and physical properties of actual lunar regolith. Combining the “correct” ratio of elements or components has generally been the main challenge that continues to be addressed. A more difficult, and arguably equally important, challenge is to make a lunar regolith simulant that replicates the physical properties of actual lunar regolith.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a number of lunar regolith particle samples, according to some embodiments.

FIG. 2 schematically illustrates regolith simulant particles in a dusty plasma, according to some embodiments.

FIG. 3 schematically illustrates accreted regolith simulant particles, according to some embodiments.

FIG. 4 schematically illustrates a system for producing regolith simulant in a dusty plasma, according to some embodiments.

FIG. 5 schematically illustrates a system for producing regolith simulant in a dusty plasma, according to other embodiments.

FIG. 6 schematically illustrates a system for producing regolith simulant in a dusty plasma, according to still other embodiments.

FIG. 7 is a flow diagram of a process for producing a regolith simulant in a dusty plasma, according to some embodiments.

### DETAILED DESCRIPTION

This disclosure describes systems and methods for producing a regolith simulant that has physical properties that are substantially the same as those of actual regolith, such as that of the Moon's surface. In particular, these systems and methods may produce regolith simulant particles (e.g., grains) that have relatively sharp, irregular, and angular shapes. Such shapes and structures are generally the same as or similar to the shapes and structures of lunar regolith particles. For example, lunar regolith particles have irregular shapes and sharp serrated edges due to the lack of weathering and erosion processes on the Moon. These shapes and structures contribute to a number of important physical characteristics demonstrated by lunar regolith. For example, irregular and angular shapes may likely lead to a relatively high quantity of interstitial spaces that result in the relatively low thermal and electrical conductivity of lunar regolith. These shapes and structures may also contribute to the well-known abrasiveness of lunar dust. Moreover, sharp and angular edges may tend to focus electromagnetic fields leading to enhanced local heating from microwave absorption (e.g., on a microscopic level). Accordingly, for a lunar regolith simulant to replicate these properties, the simulant particles should have the relatively irregular and angular shapes and structures that are produced by the systems and methods described herein. In other words, replicating just the composition of lunar regolith, and not its general physical structure, is not necessarily sufficient for a simulant to fully represent the actual regolith.

Generally, lunar regolith includes smaller-grained “soil” among the large pebbles, rocks, and boulders. The soil may include a heterogenous mix of rock fragments, minerals, glass, and glass-bonded aggregates. The lunar soil is fine and therefore often referred to as “dust.” Representative samples collected during Apollo missions show a median particle size between about 40 μm and 130 μm, and with particles smaller than 20 μm representing 10% to 20% of the weight, for example. As explained above, minerals of the dust form grains with sharp and serrated edges due to their brittle nature, leading to the abrasive nature of the dust.

As described herein, a method and system for producing a regolith simulant involves using a dusty plasma, which is a type of plasma that contains small solid particles, such as dust of various compositions, in addition to electrons and ions, suspended in an electric field. The solid particles can become electrically charged by absorbing or emitting electrons or ions from the plasma. The charged particles can interact with each other and with the electric field(s) of the plasma.

In some embodiments, a method for producing a regolith simulant includes forming a dusty plasma inside a pressure-controllable chamber and providing components (e.g., ingredients) of the regolith simulant into the chamber. For example, such components may be those that are generally found in actual regolith that was collected during the Apollo missions. These include various oxides such as those of silicon, aluminum, iron, titanium, magnesium, calcium, and potassium, just to name a few examples. Generally, components may be oxides, minerals, various compositions of matter, or chemical elements. The method further includes allowing the components to intermix in the dusty plasma. After some time, the intermixing results in irregular and angular particles, whose shapes may closely resemble those of actual lunar regolith. A latter step of the method may include collecting the formed irregular and angular particles after they have fallen, by gravity, out of the dusty plasma and into a collection vessel, such as a tray, for example.

In some implementations, the step in the method of providing the components into the dusty plasma chamber may include heating the components to a vapor state outside of the dusty plasma chamber and, while in the vapor state, injecting the components into the dusty plasma chamber. Thermal conditions in the dusty plasma chamber may be cool enough to allow the components to solidify from the vapor state. In the solid state, the components may interact with one another in the dusty plasma.

In some implementations, the step in the method of providing the components into the dusty plasma chamber may include heating the components to a vapor state outside of the dusty plasma chamber and, while in the vapor state, placing the components into an antechamber to precool the components before placing them into the dusty plasma chamber. The antechamber may be adjacent to the dusty plasma chamber and provide a dwell time for the incoming vapor of the components to cool. Resultantly, the components may be in a solid state when they arrive in the dusty plasma chamber and/or still in a vapor state, but at a temperature that is cooler than their original heated temperature.

In other implementations, the step in the method of providing the components into the dusty plasma chamber may include placing solid samples (e.g., targets) of the components inside the chamber and using an electron beam inside the chamber to sputter off the components from the solid samples of the components. For instance, different solid samples may respectively correspond to different components of the regolith simulant. One solid sample may be silicon oxide, another sample may be aluminum oxide, and still another sample may be iron oxide, just to name a few example components. Each of these samples may be placed in the chamber where it can be a target of the electron beam. In some implementations, as described below, the electron beam may be translatable or rotatable to aim at different targets at different times. The sequence of introducing the components into the dusty plasma and time span and intensity of exposure to the electron beam of individual solid samples may be controlled based on a target chemical composition of the regolith simulant or based on how the presence of different components in the dusty plasma affect formation (e.g., to a final structure) of the accreting regolith simulant. For example, providing silicon oxide before aluminum oxide may lead to formation of simulant particles that are different from the result of providing aluminum oxide before silicon oxide. For another example, in an initial part of the simulant formation process, providing silicon oxide at double the amount of aluminum oxide may lead to formation of simulant particles that are different from the result of providing aluminum oxide at double the amount of silicon oxide during the same part of the formation sequence.

In some embodiments, a system for producing a regolith simulant in a dusty plasma may include a chamber for producing the dusty plasma, an input port in a wall of the chamber to provide components of the regolith simulant into the chamber, and a region between two electrodes in the chamber that provides an electric field and allows the components to intermix in the dusty plasma to form irregular and angular particles that are the regolith simulant. A collection vessel may be in the chamber, below the dusty plasma, to collect the formed irregular and angular particles after they have fallen, by gravity, out of the dusty plasma.

In some implementations, the system may further include a heater outside of the chamber to heat the components to a vapor state and a temperature controller to provide thermal conditions in the chamber that allow the heated components to solidify from the vapor state. The system may also include an antechamber outside of the chamber to precool the components before the cooled components enter the chamber.

In some implementations, solid samples of the components may be placed in the chamber to be exposed to an electron beam, which is also in the chamber. The electron beam may sputter off small portions of each of the solid samples of the components. In this way, the components are made available in the chamber to the dusty plasma. The system may include an electronics controller to control, among other things, a time span or an intensity of exposure to the electron beam of individual solid samples of the components based on a target chemical composition and/or structure of the regolith simulant.

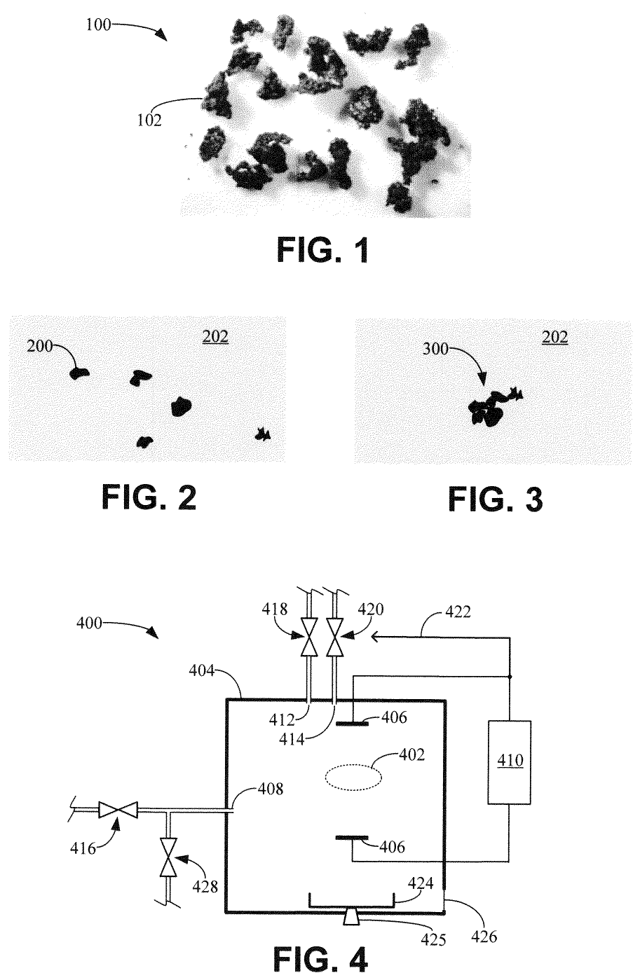

FIG. 1 illustrates a number of actual sample lunar regolith particles 100, the shapes and forms of which are what a regolith simulant should have if the simulant is to be used in experiments that are based on physical properties of regolith, according to some embodiments. For example, though the shape of a regolith particle 102 is unique, its general shape is similar to the other sample regolith particles 100 in that it has an irregular and angular shape. These lunar regolith dust particles are sharp and irregular because they have not been smoothed by weathering or erosion, unlike terrestrial dust particles. Lunar regolith dust particles formed over billions of years as a result of constant impact of meteoroids and solar wind on the lunar surface. These processes break apart rocks and minerals, melt and weld some of the dust together, and implant charged particles into the dust. The dust particles mix and redistribute by secondary impacts and electrostatic forces.

FIG. 2 schematically illustrates interactions among regolith simulant particles 200 in a dusty plasma 202, according to some embodiments. FIG. 3 schematically illustrates regolith simulant particles 200 that have been accreted in dusty plasma 202 to form a larger, single irregular and angular particle 300, according to some embodiments. A dusty plasma is a type of plasma that contains small solid particles, such as dust of various compositions, in addition to electrons and ions. The solid particles can become electrically charged by absorbing or emitting electrons or ions from the plasma. The charged particles can interact with each other and with the electric (and sometimes magnetic) fields of the plasma. The particles may levitate in the plasma that is maintained, at least in part, by the electric field formed by electrodes that produce an electric force that at least partially opposes the force of gravity. Repulsive Coulomb dust-dust forces, the friction force of a surrounding gas, drag exerted by the neutral atoms or molecules, and an ion drag force, among other things, may also contribute to particle levitation in the dusty plasma.

Particles build up in a dusty plasma by various processes, such as sputtering, agglomeration, and accretion. Sputtering may occur when energetic ions or electrons from the dusty plasma hit a particle and knock off atoms or molecules from its surface and form one or more different particles. Agglomeration may occur when particles in the dusty plasma collide with one another and stick together to form larger particles. Accretion may occur when particles are exposed to reactive gases or vapors in the dusty plasma and grow by absorbing or depositing atoms or molecules on their surface. These processes can result in different sizes and shapes of particles in the dusty plasma, ranging from nanometers to micrometers. The size and shape of the particles affect their charging, dynamics, and interactions in the dusty plasma. Generally, larger particles tend to fall downward by gravity out of the dusty plasma region. Particle 300 may be large enough, for example, to fall out of the dusty plasma by gravity. Particle 300 may qualify as being a regolith simulant by having a shape (e.g., irregular and angular) and chemical composition that is the same as or similar to regolith found on the Moon.

FIG. 4 schematically illustrates a system 400 for producing regolith simulant in a dusty plasma 402, according to some embodiments. The system may include a pressure-controllable chamber 404 that is configured to create and contain the dusty plasma. Chamber 404 may also contain various elements to form and maintain the dusty plasma, such as electrodes 406 and a port 408 through a wall of the chamber to supply gases to chamber 404 or remove gases from within the chamber. The system, via electrodes 406, may produce a radio-frequency dusty plasma (e.g., 402). Accordingly, an electronics controller 410 may be configured to control the voltage on the electrodes and the voltage frequency and duty cycle. The system, via controller 410, may also operate a DC (e.g., constant voltage) dusty plasma (e.g., 402).

One or more ports entering chamber 404 may be used to introduce components (e.g., ingredients) of regolith simulant into dusty plasma 402. For example, a first component port 412 and a second component port 414 may be used to inject first and second components, respectively, into the chamber. These components may be among a number of additional ingredients used to form the regolith simulant in dusty plasma 402. Though only these two component ports are illustrated and described, system 400 may include additional component ports to introduce additional ingredients of the regolith simulant into the chamber. In some implementations, more than one component (e.g., ingredient) of the regolith simulant may be injected into chamber 404 via one component port, instead of just one component per one port. For example, iron oxide may enter chamber 404 via component port 412 and calcium oxide may enter the chamber via component port 414. In another example, both iron oxide and calcium oxide may enter the chamber via component port 412 and silicon oxide may enter the chamber via component port 414. In still another example, iron oxide may enter the chamber via component port 412, both calcium oxide and aluminum oxide may enter the chamber via component port 414, and silicon oxide may enter the chamber via a third (not illustrated) component port.

Components injected into chamber 404 may either be in a solid state or a vapor state. For example, in a solid state, at least some of the components may be in the form of small-grained dust, such as a fine powder. In particular, some components may be injected (via their respective component port) into the chamber as a solid while the other component(s) may be in a vapor form. In a vapor state, the components (which may have been heated to the vapor state by a heater outside of the chamber) may cool inside chamber 404 enough to condense into small solid particles. For example, the size of these condensed particles may be small enough so as to not fall to the bottom of the chamber before drifting into dusty plasma 402, which can suspend (e.g., levitate) the particles.

Chamber 404 may be filled with a gas such as argon, helium, or xenon, just to name a few examples. The gas may be provided to chamber 404 via port 408 and a valve 416, for example. The components can blend with the gas and also mix among themselves anywhere in the chamber and, most importantly, in dusty plasma 402, principally between electrodes 406, where the components interact and combine to form the regolith simulant. The pressure of the gas may be adjusted to be high enough to support the dusty plasma.

The composition of the regolith simulant may be varied by controlling respective valves 418 and 420 of component ports 412 and 414. In various implementations, controller 410 may adjust, as indicated by arrow 422, the degree of opening of the valves to vary the respective amounts (e.g., flow rates) of components that are available in chamber 404 to interact in dusty plasma 402. In some examples, controller 410 may establish time periods, time sequences, and/or duty cycles for opening or closing each of the valves. In other words, the controller may control the quantity and timing of injection into the chamber of each component. In this way, the regolith simulant may be formed with desired ratios of components. Another result of such valve control may be that one component is injected into the chamber a relatively long time before another component is injected. Such sequential operation of the valves may allow for an additional variable for controlling the composition and formation of the regolith simulant. For example, injecting silicon dioxide powder into the dusty plasma minutes before injecting aluminum oxide powder may result in a regolith simulant having a composition and/or structure that is different from those of a regolith simulant that was formed by injecting silicon dioxide powder and aluminum oxide powder at the same time. Such control variability may provide an advantage by enabling system 400 to produce various types of regolith simulants to mimic lunar regolith from different regions of the Moon, for example.

System 400 may also include a collection vessel 424, such as a tray, inside chamber 404. The vessel may collect regolith simulant particles that grow massive enough to fall out of dusty plasma 402 and into the vessel below. For example, as multiple components interact with one another in the dusty plasma, accretions of these components form. With time, these accretions (e.g., the regolith simulant) grow to a point in time when the downward force of gravity overcomes the various electrostatic and electrodynamic forces in the dusty plasma.

System 400 may include a weight measuring device 425 to measure weight of the formed irregular and angular particles collected in collection vessel 424. For example, the weight may indicate a time for retrieval of the collected regolith simulant from chamber 404. A port 426 may be in a wall of chamber 404 that is openable to remove the collection vessel or the collected contents (e.g., the regolith simulant) therein. Before opening port 426 for simulant removal from the chamber, a valve 428 may be opened to purge, via port 408, chamber 404 of the gases and any remaining simulant components. Alternatively, valve 428 may be opened to allow the pressure in chamber 404 to reach the ambient pressure outside the chamber (e.g., pressure equalization).

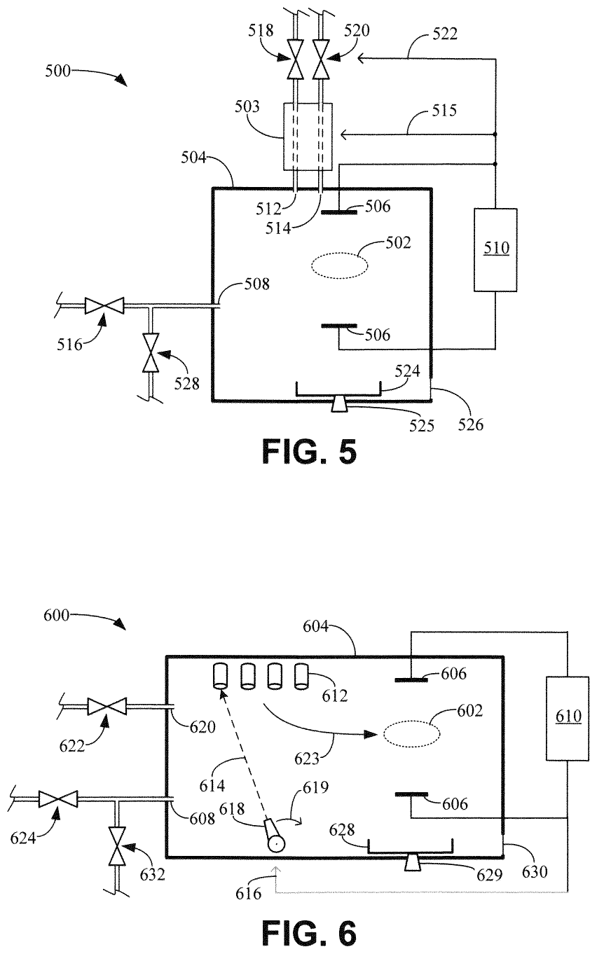

FIG. 5 schematically illustrates a system 500 for producing regolith simulant in a dusty plasma 502, according to some embodiments. System 500 is the same as or similar to system 400 except with the addition of an antechamber 503 to cool (or precool) incoming components of the regolith simulant that are in a vapor state, as described below.

The system may include a pressure-controllable chamber 504 that is configured to create and contain the dusty plasma. Chamber 504 may contain various elements to form and maintain the dusty plasma, such as electrodes 506 and a port 508 through a wall of the chamber to supply gases to chamber 504 or remove (e.g., purge) gases from within the chamber. The system may produce a radio-frequency dusty plasma (e.g., 502). Accordingly, an electronics controller 510 may be configured to control the voltage on the electrodes and the voltage frequency and duty cycle. The system, via controller 510, may also operate a DC (e.g., constant voltage) dusty plasma (e.g., 502).

A first component port 512 and a second component port 514 may be used to introduce (e.g., inject) first and second components, respectively, into the chamber. These components may be ingredients used to form the regolith simulant in dusty plasma 502. Though only these two component ports, the contents of which transit antechamber 503, are illustrated and described, system 500 may include additional component ports to introduce additional ingredients of the regolith simulant into the chamber. Additional component ports may or may not inject ingredients that have traversed antechamber 503. For example, as explained below, some component ports may inject ingredients in their solid state that do not need to be cooled by an antechamber.

As just indicated, components injected into chamber 504 may either be in a solid state or a vapor state. For example, in a solid state, at least some of the components may be in the form of small-grained dust, such as a fine powder. In particular, some components may be injected (via their respective component port) into the chamber as a solid while the other component(s) may be in a vapor state. In a vapor state, the components (which may have been heated to the vapor state by a heater outside of the chamber) may be precooled in antechamber 503 before further cooling inside chamber 504. Cooling in antechamber 503 may be enough to condense the vaporized component(s) into small solid particles that are then injected into chamber 504. In some implementations, cooling in antechamber 503 may not be enough to condense the vaporized component(s) and further cooling may occur in chamber 504 to finally condense the component(s) into small solid particles after being injected into the chamber. The size of the condensed particles may be small enough so as to not fall to the bottom of chamber 504 before drifting into dusty plasma 502 where electrostatic forces can levitate the particles.

In some implementations, when two or more vaporized components traverse antechamber 503 to be injected via a single component port, one of these components may condense into a solid state while the other(s) remains in a vapor state, for example. This may be because different components generally have different condensation temperatures. In various implementations, controller 510 may adjust, as indicated by arrow 515, the temperature of antechamber 503.

In some implementations, more than one component (e.g., ingredient) of the regolith simulant may be injected into chamber 504 via one component port, instead of one component per one port. In such cases, the multiple components need not all be in the same state. For example, iron oxide may enter chamber 504 via component port 512 and calcium oxide may enter the chamber via component port 514. In another example, iron oxide in a solid state and calcium oxide in a vapor state may enter the chamber via component port 512 and silicon oxide in a solid state may enter the chamber via component port 514. In still another example, iron oxide may enter the chamber via component port 512, both solid calcium oxide and vaporized aluminum oxide may enter the chamber via component port 514, and silicon oxide vapor may enter the chamber via a third (not illustrated) component port.

Chamber 504 may be filled with a gas such as argon, helium, or xenon, just to name a few examples. The gas may be provided to chamber 504 via port 508 and a valve 516, for example. The pressure of the gas may be adjusted to be high enough to support the dusty plasma.

The composition of the regolith simulant may be varied by controlling respective valves 518 and 520 of component ports 512 and 514. In various implementations, controller 510 may adjust, as indicated by arrow 522, the degree of opening of the valves to vary the respective amounts (e.g., flow rates) of components that are available in chamber 504 to interact in dusty plasma 502. In some examples, controller 510 may establish time periods, time sequences, and/or duty cycles for opening or closing each of the valves. In other words, the controller may control the quantity and timing of injection into the chamber of each component. In this way, the regolith simulant may be formed with desired ratios of components. Another result of such valve control may be that one component is injected into the chamber a relatively long time before another component is injected. Such sequential operation of the valves may allow for an additional variable for controlling the composition and formation of the regolith simulant. For example, injecting silicon dioxide powder or vapor into the dusty plasma minutes before injecting aluminum oxide powder or vapor may result in a regolith simulant having a composition and/or structure that is different from those of a regolith simulant that was formed by injecting silicon dioxide powder or vapor and aluminum oxide powder or vapor at the same time. Such control variability may provide an advantage by enabling system 500 to produce various types of regolith simulants to mimic lunar regolith from different regions of the Moon, for example.

System 500 may also include a collection vessel 524 inside chamber 504. The vessel may collect regolith simulant particles that grow massive enough to fall out of dusty plasma 502 and into the vessel below. Such falling may also occur when electrodes 506 are deactivated (e.g., turned off) or if the voltage thereof is lowered enough to sufficiently weaken the electric field of the dusty plasma. For example, as multiple components interact with one another in the dusty plasma, accretions of these components form. With time, these accretions (e.g., the regolith simulant) grow to a point in time when the downward force of gravity overcomes the various electrostatic and electrodynamic forces in the dusty plasma. In some implementations, desired regolith simulant particle size may be too small to rely on gravity to pull the particles out of the dusty plasma. In such cases, the electric field produced by the electrodes may be reduced or turned off to allow the particles to fall into collection vessel 524.

System 500 may include a weight measuring device 525 to measure weight of the formed irregular and angular particles collected in collection vessel 524. For example, the weight may indicate a time for retrieval of the collected regolith simulant from chamber 504. A port 526 may be in a wall of chamber 504 that is openable to remove the collection vessel or the collected contents (e.g., the regolith simulant) therein. Before opening port 526 for simulant removal from the chamber, a valve 528 may be opened to purge, via port 508, chamber 504 of the gases and any remaining simulant components. Alternatively, valve 528 may be opened to allow the pressure in chamber 504 to reach the ambient pressure outside the chamber (e.g., pressure equalization).

FIG. 6 schematically illustrates a system 600 for producing regolith simulant in a dusty plasma 602, according to some embodiments. The system may include a pressure-controllable chamber 604 that is configured to create and contain the dusty plasma. Chamber 604 may contain various elements to form and maintain the dusty plasma, such as electrodes 606 and a port 608 through a wall of the chamber to supply gases to chamber 604 or remove (e.g., purge) gases from within the chamber. The system may produce a radio-frequency dusty plasma (e.g., 602). In such implementations, an electronics controller 610 may be configured to control the voltage on the electrodes and the voltage frequency and duty cycle. The system, in other implementations, via controller 610, may also operate a DC (e.g., constant voltage) dusty plasma (e.g., 602).

System 600 may include solid samples 612 of at least some of the components to be included in the regolith simulant. The solid samples may be placed in the chamber to be exposed to an electron beam 614, which is also in the chamber. The electron beam may sputter off small portions of each of solid samples 612 of the components. In this way, the components are made available in the chamber to dusty plasma 602. Electronics controller 610 may control, as indicated by arrow 616, an electron beam emitter 618 that produces electron beam 614. For example, emitter 618 may produce the electron beam with an energy in the order of 10 keV and a current of tens of milliamperes, though claimed subject matter is not so limited. Electron beam 614 may be pulsed and collimated to a few millimeter-size spot and aimed at any of solid samples 612. In some implementations, controller 610 may adjust the direction of electron beam 614 by rotating, as indicated by arrow 619, electron beam emitter 618. Instead of, or in addition to, rotating emitter 618, electron beam direction may be controlled by accelerating (e.g., in a curved path) the electrons in a magnetic and/or electric field that is adjustable by controller 610. Electronics controller 610 may also control a time span or an intensity of exposure to electron beam 614 of individual solid samples of the components based on a target chemical composition of the regolith simulant.

In some implementations, one or more component ports 620 may be used to introduce (e.g., inject) one or more other components into the chamber. In other words, in addition to sputtering off solid samples of some components, other components may be introduced into the chamber via port 620, which is adjustable by a valve 622, for example. Whether from solid samples 612 or from component port(s) 620, these components may be ingredients used to form the regolith simulant in dusty plasma 602. For example, as indicated by arrow 623, regardless of their sources, all of the components may also mix among themselves anywhere in the chamber and, most importantly, in dusty plasma 602, principally between electrodes 606, where the components interact and combine to form the regolith simulant.

Chamber 604 may be filled with a gas such as argon, helium, or xenon, just to name a few examples. The gas may be provided to chamber 604 via port 608 and a valve 624, for example. The pressure of the gas may be adjusted to be high enough to support dusty plasma 602 while being low enough to allow electron beam 614 to propagate between emitter 618 and samples 612.

As mentioned above, the composition of the regolith simulant may be varied by controlling a time span or an intensity of exposure to electron beam 614 of individual solid samples 612 of the components based on a target chemical composition of the regolith simulant. In some examples, for each solid sample 612, controller 610 may establish time periods, time sequences, and/or duty cycles for electron beam 614. In other words, the controller may control the intensity and timing of the electron beam for each solid sample. This may be done, in part, by controller 610 adjusting the direction, and dwell time at a particular direction, of electron beam 614. In this way, the regolith simulant may be formed with desired ratios of components. Another result of controlling the intensity, timing, and direction of electron beam 614 may be that one component is sputtered off into the chamber a relatively long time before another component is sputtered off. Such sequential operation may allow for an additional variable for controlling the composition and formation of the regolith simulant. For example, sputtering off silicon dioxide minutes before sputtering off aluminum oxide may result in a regolith simulant having a composition and/or structure that is different from those of a regolith simulant that was formed by sputtering off silicon dioxide and aluminum oxide at substantially the same time (e.g., by an electron beam having a sufficiently wide spot size, more than one electron beam being used, or a single solid sample 612 comprising more than one component). Such control variability may provide an advantage by enabling system 600 to produce various types of regolith simulants to mimic lunar regolith from different regions of the Moon, for example.

System 600 may also include a collection vessel 628 inside chamber 604. The vessel may collect regolith simulant particles that grow massive enough to fall out of dusty plasma 602 and into the vessel below. For example, as multiple components interact with one another in the dusty plasma, accretions of these components form. With time, these accretions (e.g., the regolith simulant) grow to a point in time when the downward force of gravity overcomes the various electrostatic and electrodynamic forces in the dusty plasma.

System 600 may include a weight measuring device 629 to measure weight of the formed irregular and angular particles collected in collection vessel 628. For example, the weight may indicate a time for retrieval of the collected regolith simulant from chamber 604. A port 630 may be in a wall of chamber 604 that is openable to remove the collection vessel or the collected contents (e.g., the regolith simulant) therein. Before opening port 630 for simulant removal from the chamber, a valve 632 may be opened to purge, via port 608, chamber 604 of the gases and any remaining simulant components. Alternatively, valve 632 may be opened to allow the pressure in chamber 604 to reach the ambient pressure outside the chamber (e.g., pressure equalization). In some embodiments, controller 610 may automatically operate port 630 and valve 632 in response to monitoring and receiving measurements from weight measuring device 629.

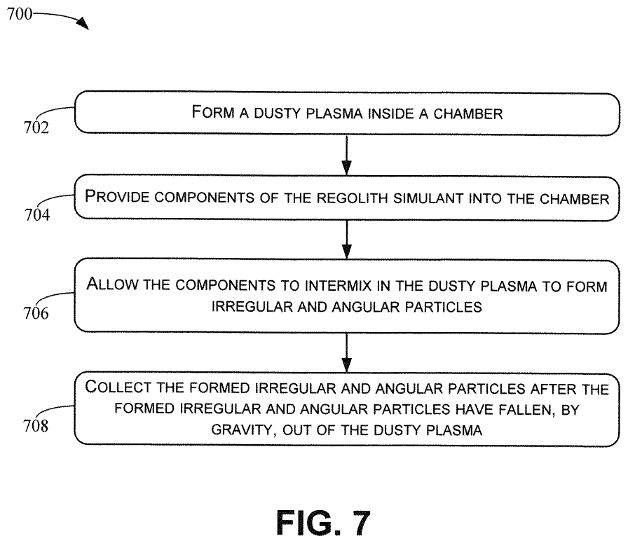

FIG. 7 is a flow diagram of a process 700 for producing a regolith simulant in a dusty plasma. The process may be performed by an operator, which may be a person or persons, a computer processor executing (e.g., via controller 410, 510, or 610) computer-readable code, or a combination thereof. The process may be performed by the operator using system 400, 500, 600, or variations of such systems, just to name a few examples. Claimed subject matter is not limited to any particular system.

At 702, the operator may form a dusty plasma inside a chamber. This may be done by energizing electrodes (e.g., 406), providing a gas, such as an inert gas, into the chamber, and also providing precursor particles (e.g., dust) into the chamber. The precursor particles may include components of the regolith simulant that is to be produced in the dusty plasma. In some implementations, the precursor particles may be something other than what is to be included in the regolith simulant. In such implementations, the precursor particles may function as a catalyst or reactant that can promote the production or accretion of the regolith simulant particles in the dusty plasma.

At 704, the operator may provide components of the regolith simulant into the chamber. Such components may include various minerals or oxides such as silicon oxide, aluminum oxide, or iron oxide. In some implementations, the components may be heated to a vapor state before entering the chamber. Thus, the components may enter the chamber while being in the vapor state. Thermal conditions in the chamber may allow the components to solidify from the vapor state. In some implementations, the system may include an antechamber (e.g., 503) outside of the chamber to precool the vaporized components before they enter the chamber.

In some embodiments, providing the components into the chamber includes placing solid samples of the components inside the chamber where they can be exposed to an electron beam. Such exposure may sputter off the components from the solid samples, thus leading to the availability of small particles of the components to the dusty plasma. In some implementations, a controller (e.g., 610) may control a time span or an intensity of exposure to the electron beam of individual solid samples of the solid samples of the components based on a target composition of the regolith simulant.

At 706, the operator may allow the components to intermix in the dusty plasma to form irregular and angular particles of regolith simulant. In some cases, a controller may control a time span of exposure to the dusty plasma of the components based on a target size distribution of the regolith simulant. In other words, the controller may control how long the components are in the dusty plasma.

At 708, the operator may collect, such as in a container below the dusty plasma, the formed irregular and angular regolith simulant particles after they have fallen, by gravity, out of the dusty plasma. In some implementations, as mentioned above, desired regolith simulant particle size may be too small to rely on gravity to pull the particles out of the dusty plasma. In such cases, the operator may reduce or turn off the electric field produced by the electrodes to allow the particles to fall into collection vessel 524.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for producing a regolith simulant in a dusty plasma, the method comprising:
forming a dusty plasma inside a chamber;
providing components of the regolith simulant into the chamber;
allowing the components to intermix in the dusty plasma to form irregular and angular particles of the regolith simulant; and
collecting the formed irregular and angular particles of the regolith simulant after the formed irregular and angular particles of the regolith simulant have fallen, by gravity, out of the dusty plasma.

2. The method of claim 1, wherein the components include a silicon oxide, an aluminum oxide, and an iron oxide.

3. The method of claim 1, wherein collecting the formed irregular and angular particles of the regolith simulant comprises collecting the formed irregular and angular particles of the regolith simulant in a container below the dusty plasma.

4. The method of claim 1, wherein providing the components into the chamber comprises:
outside of the chamber, heating the components to a vapor state;
while in the vapor state, injecting the components into the chamber; and
providing thermal conditions in the chamber that allow the components to solidify from the vapor state.

5. The method of claim 1, wherein providing the components into the chamber comprises:
outside of the chamber, heating the components to a vapor state;
while in the vapor state, placing the components into an antechamber to cool the components; and
injecting the cooled components into the chamber.

6. The method of claim 1, wherein providing the components into the chamber comprises:
injecting different components into the chamber via different ports; and
controlling rates of flow of the different components based on a target composition or target structure of the regolith simulant.

7. The method of claim 6, wherein providing the components into the chamber further comprises controlling a sequence of the injection of the different components based on the target composition or target structure of the regolith simulant.

8. The method of claim 1, wherein providing the components into the chamber comprises:
placing solid samples of the components inside the chamber; and
using an electron beam inside the chamber to sputter off the components from the solid samples of the components.

9. The method of claim 8, wherein providing the components into the chamber further comprises:
controlling a time span or an intensity of exposure to the electron beam of individual solid samples of the solid samples of the components based on a target composition of the regolith simulant.

10. The method of claim 8, wherein providing the components into the chamber further comprises:
controlling a sequence of exposure to the electron beam of individual solid samples of the solid samples of the components based on a target composition or target structure of the regolith simulant.

11. The method of claim 1, further comprising:
controlling a time span of exposure to the dusty plasma of the components based on a target size distribution of the regolith simulant.

12. The method of claim 1, wherein collecting the formed irregular and angular particles of the regolith simulant comprises deactivating an electric field that produces the dusty plasma to allow the formed irregular and angular particles of the regolith simulant to fall into a container below the electrodes.

13. A system for producing a regolith simulant in a dusty plasma, the system comprising:
a chamber for producing the dusty plasma;
an input port in a wall of the chamber to provide components of the regolith simulant into the chamber;
a region between two electrodes in the chamber that allows the components to intermix in the dusty plasma to form irregular and angular particles of the regolith simulant; and
a collection vessel in the chamber to collect the formed irregular and angular particles of the regolith simulant after the formed irregular and angular particles of the regolith simulant have fallen, by gravity, out of the dusty plasma.

14. The system of claim 13, wherein the components include a silicon oxide, an aluminum oxide, and an iron oxide.

15. The system of claim 13, further comprising:
a heater outside of the chamber to heat at least some of the components to a vapor state; and
a temperature control to provide thermal conditions in the chamber that allow the components to solidify from the vapor state.

16. The system of claim 15, further comprising an antechamber outside of the chamber to cool at least some of the components before the cooled components enter the chamber.

17. The system of claim 13, further comprising:
solid samples of the components inside the chamber; and
an electron beam inside the chamber to sputter off the components from the solid samples of the components.

18. The system of claim 17, further comprising:
an electronics controller to control a time span or an intensity of exposure to the electron beam of individual solid samples of the solid samples of the components based on a target chemical composition of the regolith simulant.

19. The system of claim 13, further comprising:
an electronics controller to control a time span of exposure to the dusty plasma of the components based on a target size distribution of the regolith simulant.

20. The system of claim 13, further comprising a weight measuring device to measure weight of the formed irregular and angular particles collected in the collection vessel.
